(19) United States
(12) Patent Application Publication
(10) Pub. No.: US 2026/0121091 A1
(43) Pub. Date: Apr. 30, 2026

(54) TEST SYSTEMS FOR LOW-POWER HYDROGEN FUEL CELL

(71) Applicant: SICHUAN QINGLV TECHNOLOGY CO., LTD., Chengdu (CN)

(72) Inventors: Zongbo FAN, Chengdu (CN); Xingxing CUI, Chengdu (CN); Shitong ZHAO, Chengdu (CN)

(73) Assignee: SICHUAN QINGLV TECHNOLOGY CO., LTD., Chengdu (CN)

(21) Appl. No.: 19/375,508

(22) Filed: Oct. 31, 2025

(30) Foreign Application Priority Data
Oct. 31, 2024 (CN) 202411537527.8

(51) Int. Cl. H01M 8/0438; H01M 8/04007; H01M 8/04029; H01M 8/04082; H01M 8/04111; H01M 8/0432; H01M 8/04746; H01M 8/10

(52) U.S. Cl. CPC H01M 8/04388; H01M 8/04029; H01M 8/04067; H01M 8/04111; H01M 8/04201; H01M 8/04343; H01M 8/04753; H01M 8/04768; H01M 2008/1095

(57) ABSTRACT

Provided is a test system for a low-power hydrogen fuel cell, including: an anode hydrogen control component, a cathode oxygen control component, and a coolant circulation component. The anode hydrogen control component includes a hydrogen supply pump in communication with an anode side of a cell under test, and a proton flowmeter in communication with an anode exhaust port of the cell under test. The cathode oxygen control component includes a blower in communication with a cathode side of the cell under test, a PWM duty cycle controller electrically connected to the blower, and a cathode rotameter in communication with a cathode exhaust port of the cell under test; two ends of the coolant circulation component is in communication with a cooling chamber inlet and a cooling chamber outlet of the cell under test, respectively.

### CROSS-REFERENCE TO RELATED APPLICATIONS

This application claims priority to the Chinese Patent Application No. 202411537527.8, filed on Oct. 31, 2024, the contents of which are hereby incorporated by reference.

### TECHNICAL FIELD

The present disclosure relates to a technical field of fuel cells, and in particular to a test system for a low-power hydrogen fuel cell.

### BACKGROUND

With a global energy structure transforming towards cleanliness and high efficiency, a hydrogen fuel cell, as one of the clean energy technologies, has received widespread attention. Especially in a field of low-power applications, such as portable power supplies and small unmanned aerial vehicles (UAVs), a low-power hydrogen fuel cell demonstrates great application potential due to its characteristics of high efficiency and zero emissions. However, the development and optimization of the low-power hydrogen fuel cell face many challenges, among which the most critical is how to effectively control the operating state of the low-power hydrogen fuel cell to ensure stability and reliability under different load conditions.

Existing test systems for the low-power hydrogen fuel cell often suffer from insufficient control accuracy, particularly in gas supply and temperature management. For a fuel cell stack or a single fuel cell, the supply of anode and cathode gases is an important factor for determining the performance of the fuel cell stack or the single fuel cell. Pressure and flow rate of the gases directly affect output power and efficiency of the fuel cell. If precise control of these parameters cannot be achieved, it will be difficult to accurately evaluate the real performance of the fuel cell, thereby affecting design optimization and performance improvement of the fuel cell. Additionally, the fuel cell generates a large amount of heat during operation. If the heat cannot be effectively managed, the temperature of the fuel cell may become too high, which not only reduces the efficiency of the fuel cell but may also cause irreversible damage to the fuel cell.

### SUMMARY

To overcome defects of the prior art, the present disclosure provides a test system for a low-power hydrogen fuel cell, which can solve technical problems of low control accuracy for hydrogen, oxygen, and a temperature of the fuel cell, as well as poor heat dissipation effect in current test systems.

An objective of the present disclosure is achieved through the following technical solutions:

The present disclosure provides a test system for a low-power hydrogen fuel cell, comprising: an anode hydrogen control component, a cathode oxygen control component, and a coolant circulation component; wherein the anode hydrogen control component includes a hydrogen supply pump and a proton flowmeter, the hydrogen supply pump is in communication with an anode side of a cell under test, and the proton flowmeter is in communication with an anode exhaust port of the cell under test; the cathode oxygen control component includes a blower, a pulse width modulation (PWM) duty cycle controller, and a cathode rotameter, the blower is in communication with a cathode side of the cell under test, the PWM duty cycle controller is electrically connected to the blower, and the cathode rotameter is in communication with a cathode exhaust port of the cell under test; one end of the coolant circulation component is in communication with a cooling chamber inlet of the cell under test, and the other end of the coolant circulation component is in communication with a cooling chamber outlet of the cell under test; a first-stage pressure reducing valve is further disposed between the hydrogen supply pump and the anode side of the cell under test; a second-stage pressure reducing valve is further disposed between the first-stage pressure reducing valve and the anode side of the cell under test; and an anode rotameter is further disposed between the second-stage pressure reducing valve and the anode side of the cell under test.

### BRIEF DESCRIPTION OF THE DRAWINGS

FIG. 1 is a diagram illustrating usage in testing of a low-power hydrogen fuel cell according to some embodiments of the present disclosure;

FIG. 2 is a schematic diagram illustrating a result of a test example of the present disclosure.

### REFERENCE NUMERALS

1: cell under test, 101: anode side, 102: anode exhaust port, 103: cathode side, 104: cathode exhaust port, 2: hydrogen supply pump, 3: first-stage pressure reducing valve, 4: second-stage pressure reducing valve, 5: anode rotameter, 6: solenoid valve, 7: proton flowmeter, 8: blower, 9: PWM duty cycle controller, 10: cathode rotameter, 11: relay, 12: temperature controller, 13: water pump, 14: water-cooled radiator, 15: cooling fan.

### DETAILED DESCRIPTION

The present disclosure is further described below with reference to the drawings.

### Embodiments

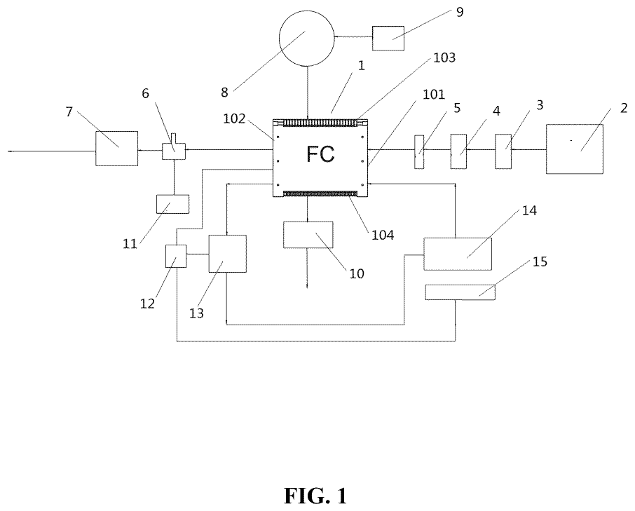

FIG. 1 is a diagram illustrating usage in testing of a low-power hydrogen fuel cell according to some embodiments of the present disclosure.

The present disclosure provides a test system for a low-power hydrogen fuel cell, including: an anode hydrogen control component, a cathode oxygen control component, and a coolant circulation component.

The anode hydrogen control component includes a hydrogen supply pump 2 and a proton flowmeter 7, the hydrogen supply pump 2 is in communication with an anode side 101 of a cell under test 1, and the proton flowmeter 7 is in communication with an anode exhaust port 102 of the cell under test 1; the cathode oxygen control component includes a blower 8, a pulse width modulation (PWM) duty cycle controller 9, and a cathode rotameter 10, the blower 8 is in communication with a cathode side 103 of the cell under test 1, the PWM duty cycle controller 9 is electrically connected to the blower 8, and the cathode rotameter 10 is in communication with a cathode exhaust port 104 of the cell under test 1; one end of the coolant circulation component is in communication with a cooling chamber inlet of the cell under test 1, and the other end of the coolant circulation component is in communication with a cooling chamber outlet of the cell under test 1; a first-stage pressure reducing valve 3 is further disposed between the hydrogen supply pump 2 and the anode side 101 of the cell under test 1; a second-stage pressure reducing valve 4 is further disposed between the first-stage pressure reducing valve 3 and the anode side 101 of the cell under test 1; and an anode rotameter 5 is further disposed between the second-stage pressure reducing valve 4 and the anode side 101 of the cell under test 1.

The test system for a low-power hydrogen fuel cell (also referred to as the test system) refers to an integrated device that tests the performance of the low-power hydrogen fuel cell. The test system can achieve precise adjustment and monitoring of key parameters, such as gas supply and temperature control of the fuel cell, thereby improving the accuracy and reliability of the test. The low-power hydrogen fuel cell generally refers to a hydrogen fuel cell with a power range between 50 watts and 5000 watts.

The cell under test refers to the low-power hydrogen fuel cell being tested, also referred to as the fuel cell. The cell under test may include an anode side, a cathode side, an anode exhaust port, a cathode exhaust port, a cooling chamber, etc.

The anode side and the cathode side are located on an inlet side of the fuel cell. The anode side refers to a hydrogen inlet of the fuel cell. The cathode side refers to an air (oxygen) inlet of the fuel cell. The anode side and the cathode side are respectively configured to receive hydrogen and air for a fuel cell reaction.

The anode exhaust port and the cathode exhaust port are located on an exhaust side of the cell under test. The anode exhaust port refers to a gas outlet after an anode reaction of the fuel cell and is configured to discharge unreacted hydrogen. The cathode exhaust port refers to a gas outlet after a cathode reaction of the fuel cell and is configured to discharge gases after the reaction.

The cooling chamber runs through an interior of the fuel cell and is used for heat dissipation. The cooling chamber includes a cooling chamber inlet and a cooling chamber outlet. The cooling chamber inlet is used for a coolant at a first temperature to enter the cooling chamber. The cooling chamber outlet is used for the coolant at a second temperature to exit the cooling chamber. The first temperature is lower than the second temperature.

The anode side, the cathode side, the anode exhaust port, the cathode exhaust port, the cooling chamber inlet, and the cooling chamber outlet of the fuel cell are all connected to corresponding control or measurement components of the test system through external pipelines, thereby testing the performance of the fuel cell. Connections between the anode side, the cathode side, the anode exhaust port, the cathode exhaust port, the cooling chamber inlet, and the cooling chamber outlet of the fuel cell and the control or measurement components of the test system are described in detail in the relevant descriptions below.

The anode hydrogen control component of the test system refers to a subsystem that controls hydrogen supply. In some embodiments, the anode hydrogen control component includes a hydrogen supply pump, a proton flowmeter, a pressure reducing valve, a solenoid valve, etc. The hydrogen supply pump refers to a pump device that provides hydrogen. The hydrogen supply pump is located at a starting end of the anode hydrogen control component. The hydrogen supply pump is in communication with the anode side of the cell under test. The hydrogen supply pump is configured to transport hydrogen from a gas source to the anode side of the cell under test through the pressure reducing valve. The proton flowmeter refers to a flowmeter that measures proton content (i.e., hydrogen content) in gas discharged from the anode exhaust port of the cell under test. The proton flowmeter may be installed after the anode exhaust port of the cell under test.

In the anode, the proton flowmeter 7 may observe the hydrogen content in the gas discharged from the anode exhaust port of the cell under test to determine whether the fuel cell reaction is sufficient. The proton flowmeter includes a thermal mass flowmeter (e.g., SmartTrak® 100 series from Sierra Instruments), an electrochemical hydrogen sensor (e.g., a specific model sensor from City Technology), etc. If a reading (i.e., the amount of unreacted hydrogen) displayed by the proton flowmeter is too high, it indicates that the hydrogen supply may be much greater than the demand, or the fuel cell reaction is insufficient, resulting in a low efficiency.

In some embodiments, a solenoid valve 6 is further disposed between the anode exhaust port 102 and the proton flowmeter 7. The solenoid valve refers to an electric valve that controls an on-off state of the exhaust at the anode exhaust port.

In some embodiments, the solenoid valve 6 is electrically connected to a relay 11. The relay refers to an electrical component that controls the switching of the solenoid valve.

Gas discharged from the anode exhaust port 102 of the fuel cell is discharged through the solenoid valve 6. The relay 11 controls an exhaust duration and an interval duration of the solenoid valve 6. In some embodiments, the relay 11 may control the exhaust duration and the interval duration of the solenoid valve 6 based on preset values set by a tester. In some embodiments, the relay 11 may dynamically adjust the exhaust duration and the interval duration of the solenoid valve 6 based on a voltage and/or a current of the fuel cell. For example, when the voltage of the fuel cell is lower than a preset voltage, the exhaust duration and/or the interval duration may be adjusted based on a difference between the voltage of the fuel cell and the preset voltage. The relay 11 changes the exhaust interval duration and exhaust duration to maintain the power stability of the fuel cell.

In some embodiments, the pressure reducing valve includes a first-stage pressure reducing valve 3 and a second-stage pressure reducing valve 4.

In some embodiments, the first-stage pressure reducing valve 3 is further disposed between the hydrogen supply pump 2 and the anode side 101 of the cell under test 1.

The first-stage pressure reducing valve 3 may withstand high-pressure gas from a hydrogen gas source (e.g., a pressure of the hydrogen gas source is 20 MPa). The first-stage pressure reducing valve 3 is configured to reduce the pressure to a level higher than an operating pressure of the low-power hydrogen fuel cell. For example, the pressure is reduced to 0.1-0.2 MPa. The reason for setting the pressure higher than the operating pressure of the low-power hydrogen fuel cell is to ensure that the second-stage pressure reduction can reduce the pressure to a normal operating pressure of the fuel cell, such as 0.03˜0.1 MPa, thereby avoiding potential safety hazards caused by reducing the pressure to a specified pressure.

In some embodiments, the second-stage pressure reducing valve 4 is further disposed between the first-stage pressure reducing valve 3 and the anode side 101 of the cell under test 1.

The second-stage pressure reducing valve 4 adjusts the pressure to the normal operating pressure of the fuel cell. The two-stage pressure reduction may maintain anode inlet pressure stable without sudden pressure changes. The process may be precisely adjusted manually or through electronic control.

In some embodiments, the anode rotameter 5 is further disposed between the second-stage pressure reducing valve 4 and the anode side 101 of the cell under test 1. The anode rotameter 5 refers to a device installed in an anode inlet flow path of the hydrogen fuel cell that visually and real-timely displays and measures a volumetric flow rate of hydrogen. The anode rotameter may include a glass tube rotameter, a metal tube rotameter, etc.

The gas after the second-stage pressure reduction may be observed in real-time for the anode gas flow rate through the anode rotameter 5. An optimal inlet gas flow rate is achieved by adjusting the first-stage pressure reducing valve 3, the second-stage pressure reducing valve 4, the hydrogen supply pump 2, and/or a gas source valve based on real-time flow rate display.

The cathode oxygen control component of the test system refers to a subsystem that controls air supply. The cathode oxygen control component includes a blower, a PWM duty cycle controller, a cathode rotameter, etc.

The blower refers to a fan that supplies air to the cathode. A duty cycle of the blower is adjusted by the PWM duty cycle controller, enabling the blower to provide an air flow with a controllable air volume and velocity. The cathode rotameter refers to a device that measures a cathode exhaust flow rate. The cathode rotameter is installed at the cathode exhaust port of the cell under test and is configured to monitor a cathode gas flow rate in real time and assist in adjusting the blower.

In the cathode, selection of the blower 8 may depend on a rated power of the fuel cell. The air volume and velocity of the blower 8 must satisfy an oxygen demand of the fuel cell cathode. A blocking pressure of the blower 8 must not exceed a withstand limit of a proton exchange membrane, and the blocking pressure must be lower than an inlet pressure on the anode side.

The PWM duty cycle controller 9 (model ZK-PPIK, other models may also be used) is configured to control and adjust the duty cycle of the blower 8, thereby achieving control over the air volume and velocity of the blower 8, i.e., precisely adjusting the air volume and velocity of the cathode inlet.

The cathode side of the cell under test takes in air via the blower 8. The cathode exhaust port is connected to the rotameter. The PWM duty cycle of the inlet air of the blower 8 is adjusted by observing a real-time gas flow rate and a real-time pressure of the rotameter, thereby achieving real-time observation and precise control of the gas flow rate and pressure on the cathode side.

The coolant circulation component refers to a cooling system that controls an operating temperature of the fuel cell.

After connecting the anode side, the cathode side, the anode exhaust port, the cathode exhaust port, the cooling chamber inlet, and the cooling chamber outlet of the cell under test to the control or measurement components of the test system (i.e., the anode hydrogen control component, the cathode oxygen control component, and the coolant circulation component), the test system is configured to supply stable hydrogen to the anode side of the cell under test, supply stable oxygen to the cathode side of the cell under test, and simultaneously maintain a relative constancy of the temperature of the cell under test. During the testing process, the cell under test is configured to output stable power and maintain stable efficiency, thereby accurately evaluating the real performance of the cell under test, which is beneficial for subsequent design optimization and performance improvement of the cell under test.

In some embodiments, the coolant circulation component includes a water pump 13 and a heat dissipation assembly. A water outlet of the water pump 13 is in communication with the heat dissipation assembly. A water inlet of the water pump 13 is in communication with a cooling chamber outlet of the cell under test 1. The heat dissipation assembly is connected to the cooling chamber inlet of the cell under test 1.

The water pump refers to a pump that drives a circulation of the coolant. The coolant may include water, silicone oil, or the like. The water pump is located in a coolant circulation loop and is configured to pump the coolant into the cooling chamber of the cell under test, thereby achieving heat transfer, i.e., transferring heat from the cell under test to the coolant. The coolant circulation loop refers to a circulation loop composed of the water pump, the cooling chamber of the cell under test, and the heat dissipation assembly.

The heat dissipation assembly refers to a structure with a heat dissipation function. The heat dissipation assembly may include structures such as a water-cooled radiator and a cooling fan. The heat dissipation assembly is connected between the water pump and the cooling chamber inlet of the cell under test and is configured to reduce a temperature of the coolant through air cooling and heat radiation, thereby utilizing the coolant with a reduced temperature to cool the cell under test.

In some embodiments, the heat dissipation assembly includes a water-cooled radiator 14 and a cooling fan 15. A water inlet of the water-cooled radiator 14 is in communication with the water outlet of the water pump 13. An air outlet of the cooling fan 15 is directed toward the water-cooled radiator 14. A water outlet of the water-cooled radiator 14 is connected to the cooling chamber inlet of the cell under test 1.

The water-cooled radiator refers to a heat exchanger with cooling fins. The coolant flows through an interior of the water-cooled radiator. An exterior of the water-cooled radiator is cooled by air blown from the cooling fan. The water-cooled radiator may enhance a heat dissipation area of the heat dissipation assembly and improve heat dissipation efficiency.

In some embodiments, the coolant circulation component further includes a temperature controller 12. A temperature sensing wire of the temperature controller 12 is adhesively bonded to a surface of the cell under test 1. The temperature controller 12 is controllably connected to the cooling fan 15.

The temperature controller refers to a device that monitors and controls a temperature of the fuel cell. The temperature controller may adjust an operation of the cooling fan based on the temperature of the fuel cell, thereby achieving precise temperature control. Merely by way of example, when the temperature controller detects that the temperature of the cell under test is higher than a preset threshold, the temperature controller 12 controls the fan to turn on or increases an air volume and velocity.

In some embodiments, a plurality of cooling fins are disposed on the water-cooled radiator. The cooling fin refers to a series of thin and tall extended metal sheets attached to a base surface of a radiator. The cooling fin may significantly increase a heat dissipation surface area, thereby enhancing heat exchange efficiency with a surrounding fluid.

Selection of the water pump 13 requires controlling a pressure within a pressure range bearable by fuel cell bipolar plates. A flow rate of the pump body must satisfy a basic cooling requirement (the flow rate requirement is 5 L/min to 10 L/min). In this embodiment, the flow rate of the water pump 13 is 10 L/min.

The coolant is pumped into the fuel cell by the water pump 13. After passing through the fuel cell, the temperature of the discharged coolant ranges from 60° C. to 70° C. The coolant discharged from the fuel cell enters the water-cooled radiator (the water flow channel of the water-cooled radiator is covered with the cooling fins, which increase a contact area between the coolant and air, and allow a portion of the heat to be dissipated through heat radiation). The cooling fan 15 is adjusted by the temperature controller 12. The temperature sensing wire in the temperature controller 12 is bonded to the surface of the fuel cell and is configured to measure the temperature of the fuel cell. Temperature parameters are set in the temperature controller 12. When the temperature of the fuel cell reaches or exceeds a set temperature, the temperature controller 12 controls the fan to turn on and blows air to the water-cooled radiator to reduce the temperature of the coolant, thereby achieving the purpose of controlling the temperature of the fuel cell. When the temperature changes during operation, the temperature controller 12 adjusts an air volume and velocity of the cooling fan 15, thereby achieving precise control of the temperature. Merely by way of example, the temperature controller 12 may control the fan to turn on through a switch, or control the air volume and velocity through power proportion. The coolant, after being cooled by the water-cooled radiator, flows back into the water-cooled radiator and the water pump 13 to form a coolant circulation system. In this embodiment, a model of the temperature controller 12 is AI-526. Alternatively, other models may be used.

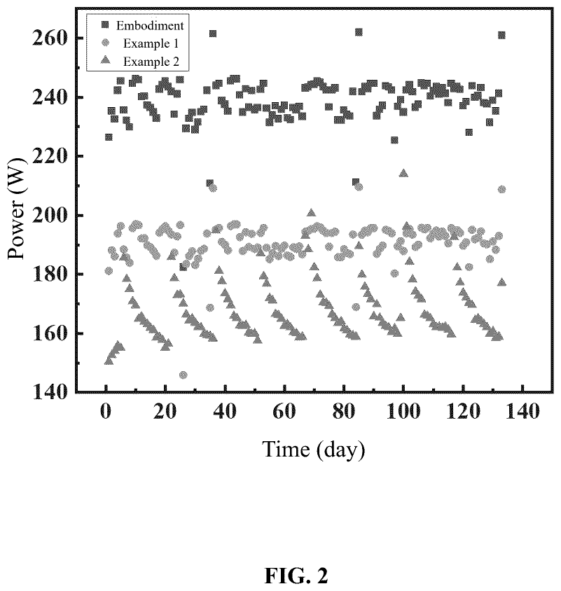

### Comparative Example 1 (Also Referred to as Example 1 in FIG. 2)

The proton flowmeter and the pressure reducing valve are used directly. The anode hydrogen control component corresponding to the anode side (i.e., the hydrogen inlet side) of the cell under test only includes the proton flowmeter and one pressure reducing valve. The cathode oxygen control component corresponding to the cathode side and the cathode exhaust port of the cell under test only includes the blower. The coolant circulation component does not include the temperature controller.

### Comparative Example 2 (Also Referred to as Example 2 in FIG. 2)

The proton flowmeter is used directly. The anode hydrogen control component corresponding to the anode side of the cell under test only includes the proton flowmeter. Other configurations are consistent with those of Comparative Example 1.

### Test Example

The fuel cell (with a catalyst layer area of 5 cm×5 cm) was subjected to power measurement from day 0 to day 140 using the devices described in the embodiments and Comparative Examples 1-2, respectively. The constant-current discharge conditions were as follows: hydrogen pressure of 0.1 MPa, air pressure of 0.1 MPa, hydrogen flow rate of 700 mL/min, air flow rate of 2800 mL/min, 60% humidification, temperature of 50-60° C., and constant-current discharge at 15 A for 200 hours. Stack power was continuously recorded, and the results obtained are shown in FIG. 2. According to the results shown in FIG. 2, the power of the fuel cell measured by the system used in the embodiments of the present disclosure is higher and closer to the actual power value of the fuel cell itself. Therefore, the system used in the present disclosure has higher accuracy in measuring the power of the fuel cell.

The beneficial effects of the present disclosure are as follows:

First, the test system provided by the present disclosure achieves precise control of the anode and cathode gas inlets for the low-power hydrogen fuel cell. By adopting a two-stage pressure reduction technology, it can not only adapt to a wide range of hydrogen pressure but also stably adjust the hydrogen pressure on the anode side to the optimal level required by the fuel cell, ensuring the continuity and stability of hydrogen supply. At the same time, the air volume and velocity of the blower are adjusted by using the PWM duty cycle controller, achieving precise control of oxygen supply on the cathode side. The precise gas management mechanism greatly improves the operating efficiency of the fuel cell, maintains the fuel cell at a stable temperature and power, thereby reducing unnecessary energy loss and helping to extend the service life of the fuel cell.

Second, the test system introduces a high-efficiency liquid cooling temperature control device, effectively solving the heat problem generated during the operation of the fuel cell. Through the collaborative work of the water pump, the water-cooled radiator, the cooling fan, and the temperature controller, it is ensured that the fuel cell can operate stably within an optimal operating temperature range. The precise temperature control not only avoids a risk of performance degradation or even damage to the fuel cell caused by excessive temperature but also improves the energy conversion efficiency of the fuel cell, further enhancing the comprehensive performance of the fuel cell.

Third, the test system has a high degree of flexibility and applicability, and is suitable for activation and performance testing of various models of low-power hydrogen fuel cells. Users can manually and precisely set relevant parameters according to actual needs, and quickly complete an entire process from activation to performance testing. The feature allows researchers to conduct fuel cell research more conveniently, accelerates the research and development process of new technologies, and promotes the advancement of hydrogen energy technology.

In the description of the present disclosure, it should be understood that the terms “upper,” “lower,” “bottom,” “top,” “front,” “rear,” “inner,” “outer,” “left,” “right,” etc., indicate orientations or positional relationships based on the orientations or positional relationships shown in the drawings. These terms are only used for the convenience of describing the present disclosure and simplifying the description, and are not intended to indicate or imply that the referred device or element must have a specific orientation or be constructed and operated in a specific orientation. Therefore, these terms should not be construed as limiting the present disclosure.

Although the present disclosure has been described with reference to specific embodiments herein, it should be understood that these embodiments are merely examples of the principles and applications of the present disclosure. Therefore, it should be understood that numerous modifications may be made to the exemplary embodiments, and other arrangements may be devised, without departing from the spirit and scope of the present disclosure as defined by the appended claims. It should be understood that different dependent claims and the features described herein may be combined in ways different from those described in the original claims. It should also be understood that features described in connection with an individual embodiment may be used in other described embodiments.

What is claimed is:

1. A test system for a low-power hydrogen fuel cell, comprising:
an anode hydrogen control component, a cathode oxygen control component, and a coolant circulation component; wherein
the anode hydrogen control component includes a hydrogen supply pump and a proton flowmeter, the hydrogen supply pump is in communication with an anode side of a cell under test, and the proton flowmeter is in communication with an anode exhaust port of the cell under test;
the cathode oxygen control component includes a blower, a pulse width modulation (PWM) duty cycle controller, and a cathode rotameter, the blower is in communication with a cathode side of the cell under test, the PWM duty cycle controller is electrically connected to the blower, and the cathode rotameter is in communication with a cathode exhaust port of the cell under test;
one end of the coolant circulation component is in communication with a cooling chamber inlet of the cell under test, and the other end of the coolant circulation component is in communication with a cooling chamber outlet of the cell under test;
a first-stage pressure reducing valve is further disposed between the hydrogen supply pump and the anode side of the cell under test;
a second-stage pressure reducing valve is further disposed between the first-stage pressure reducing valve and the anode side of the cell under test; and
an anode rotameter is further disposed between the second-stage pressure reducing valve and the anode side of the cell under test.

2. The test system according to claim 1, wherein a solenoid valve is further disposed between the anode exhaust port and the proton flowmeter.

3. The test system according to claim 2, wherein the solenoid valve is electrically connected to a relay.

4. The test system according to claim 1, wherein the coolant circulation component includes a water pump and a heat dissipation assembly, a water outlet of the water pump is in communication with the heat dissipation assembly, a water inlet of the water pump is in communication with the cooling chamber outlet of the cell under test, and the heat dissipation assembly is connected to the cooling chamber inlet of the cell under test.

5. The test system according to claim 4, wherein the heat dissipation assembly includes a water-cooled radiator and a cooling fan, a water inlet of the water-cooled radiator is in communication with the water outlet of the water pump, an air outlet of the cooling fan is directed toward the water-cooled radiator, and a water outlet of the water-cooled radiator is connected to the cooling chamber inlet of the cell under test.

6. The test system according to claim 5, wherein the coolant circulation component further includes a temperature controller, a temperature sensing wire of the temperature controller is adhesively bonded to a surface of the cell under test, and the temperature controller is controllably connected to the cooling fan.

7. The test system according to claim 6, wherein a plurality of cooling fins are disposed on the water-cooled radiator.
